(19) United States
(12) Patent Application Publication
(10) Pub. No.: US 2014/0368862 A1
(43) Pub. Date: Dec. 18, 2014

(54) INFORMATION PROCESSING APPARATUS, INFORMATION PROCESSING SYSTEM, CONTROLLING METHOD THEREOF, AND PROGRAM

(71) Applicant: CANON KABUSHIKI KAISHA, Tokyo (JP)

(72) Inventor: Hideaki Ooba, Yokohama-shi (JP)

(21) Appl. No.: 14/297,257

(22) Filed: Jun. 5, 2014

(30) Foreign Application Priority Data
Jun. 14, 2013 (JP) 2013-125908

(51) Int. Cl. G06F 3/12

(52) U.S. Cl. CPC G06F 3/1221; G06F 3/1229
USPC 358/1.14

(57) ABSTRACT

The present invention provides an image processing controller which can, even if the image processing controller is in a power saving state, return from the power saving state in response to data transmitted from an image forming apparatus, transfer the data to a network, shift to the power saving state without wasted motion after termination of the transfer of the data, and thus achieve power saving without impairing convenience.

### BACKGROUND OF THE INVENTION

1. Field of the Invention

The present invention relates to, for example, an information processing system in which an image processing apparatus and an image processing controller perform an image process in cooperation with each other.

2. Description of the Related Art

Recently, in response to a demand for power saving to various apparatuses such as an image forming apparatus and the like, a technique for changing the power state of the image forming apparatus to a power saving state on the condition that, for example, the image forming apparatus is not operated for a certain time has been proposed (see Japanese Patent Application Laid-Open No. 2010-2500). The image forming apparatus like this shifts to the power saving state if a certain time or more elapses after a printing process by a printer unit and a scanning process by a scanner are terminated, or if a certain time or more elapses after communication with an external device is terminated.

Incidentally, there is a case where the image forming apparatus is connected to an image processing controller which performs an image process in cooperation with the relevant image forming apparatus. In this case, also the image processing controller shifts to the power saving state if any printing data is not processed for a certain time by the image processing controller, or if the image processing controller is not accessed for a certain time from another information processing apparatus on a network.

However, in the above information processing system, the following problem occurs. Namely, as described above, the image forming apparatus is connected to the network through the image processing controller. Therefore, if data is transmitted from the image forming apparatus to an external server when the image processing controller is in the power saving state, it is necessary to once return the image processing controller from the power saving state and then transmit the data to the external server. For this reason, according to a condition that the image processing controller returns from the power saving state, there is a case where the image processing controller does not actually return from the power saving state and thus the image processing controller is still in the power saving state, so that the image forming apparatus cannot process the data intended to be transmitted to the external server through the image processing controller.

Incidentally, even if the image processing controller returns from the power saving state and thus the image forming apparatus can process the data intended to be transmitted to the external server, the image processing controller inevitably maintains its activated state until the condition for shifting the image processing controller to the power saving state is again satisfied. In this case, another problem occurs from the viewpoint of power saving.

### SUMMARY OF THE INVENTION

The present invention has been completed in order to solve the above problems, and an object thereof is to provide a mechanism which can, even if an information processing apparatus such as an image processing controller or the like is in a power saving state, return from the power saving state in response to data transmitted from an image forming apparatus, process the data (for example, transfer the data to a network), shift to the power saving state without wasted motion after termination of the process, and thus achieve power saving without impairing convenience.

To achieve the above object, the present invention is directed to an information processing apparatus, capable of communicating with the image forming apparatus, generating raster image data in response to a print request received from an external apparatus, and transmitting the generated raster image data to the image forming apparatus, which is characterized by comprising: a receiving unit configured to receive a packet from the image forming apparatus through the network; and a controlling unit configured to, in a case where the packet received by the receiving unit is a packet addressed to another apparatus different from the information processing apparatus, return the information processing apparatus from the power saving state.

According to the present invention, it is possible to, even if the information processing apparatus such as the image processing controller or the like is in the power saving state, return from the power saving state in response to the data transmitted from the image forming apparatus, process the data, shift to the power saving state without wasted motion after the termination of the process, and thus achieve the power saving without impairing the convenience.

Further features of the present invention will become apparent from the following description of exemplary embodiments with reference to the attached drawings.

### BRIEF DESCRIPTION OF THE DRAWINGS

FIG. 1 is a block diagram illustrating an example of an information processing system according to the present invention.

FIG. 2 is a block diagram illustrating hardware constitutions of an image forming apparatus and an image processing controller.

FIG. 3 is a diagram illustrating an example of a power supply circuit constitution of the image forming apparatus.

FIG. 4 is a block diagram illustrating a hardware constitution of a network interface.

FIG. 5 is a block diagram illustrating a software configuration of the image processing controller.

FIG. 6 is a diagram for describing power state shifts of the image forming apparatus and the image processing controller.

FIG. 7 is a flow chart for describing an operation of the image processing controller according to a first embodiment.

FIG. 8 is a diagram illustrating an example of power supply state shift conditions of the image processing controller according to the first embodiment.

FIG. 9 is a flow chart for describing an operation of the image forming apparatus according to the first embodiment.

FIG. 10 is a flow chart for describing an operation of the image processing controller according to a second embodiment.

FIG. 11 is a diagram illustrating an example of power supply state shift conditions of the image processing controller according to the second embodiment.

FIG. 12 is a flow chart for describing an example of an operation to be performed when the image forming apparatus according to the second embodiment is activated.

FIG. 13 is a flow chart for describing an operation of the image forming apparatus according to the second embodiment.

FIG. 14 is a diagram illustrating an example of a monitoring information registration screen according to a third embodiment.

FIG. 15 is a diagram illustrating an example of a monitoring information new registration screen according to the third embodiment.

FIG. 16 is a flow chart for describing an example of an operation of the image processing controller according to the third embodiment.

FIG. 17 is a flow chart for describing an operation of the image forming apparatus according to the third embodiment.

FIG. 18 is a diagram illustrating an example of a power supply circuit constitution of the image processing controller.

### DESCRIPTION OF THE EMBODIMENTS

Hereinafter, preferred embodiments of the present invention will be described in detail with reference to the attached drawings.

### First Embodiment

<Entire Configuration of Image Forming System>

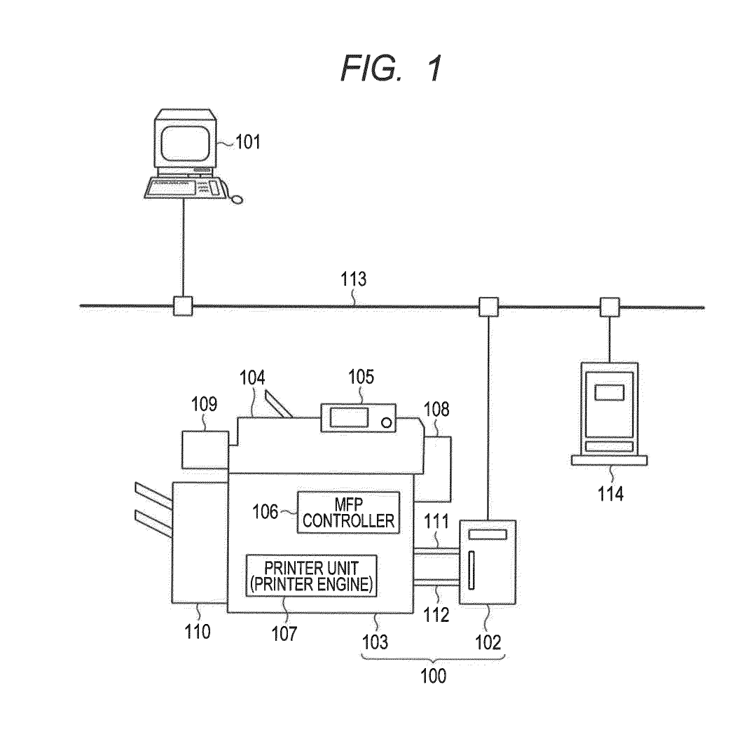

FIG. 1 is a block diagram illustrating an example of an entire configuration of an image forming system which is applicable to an information processing system according to the present invention. In FIG. 1, an image forming system 100 serves as the information processing system according to the present invention. The image forming system 100, which is equipped with an image processing controller 102 and an image forming apparatus 103, is communicably connected to a client computer 101.

The client computer 101 and the image processing controller 102 are communicably connected to each other through a LAN (local area network) 113. Further, the image processing controller 102 and the image forming apparatus 103 are communicated with each other through a control cable 111 and an image video cable 112. Incidentally, in the present embodiment, the image forming apparatus 103 is not directly connected to the LAN 113. That is, the image forming apparatus 103 and the client computer 101 communicate with each other through the image processing controller 102. Incidentally, the image forming apparatus 103 may be connected to the LAN 113.

The client computer 101 starts its applications and thus transmits a printing instruction and the like to the image forming apparatus 103. The image processing controller 102 performs an image process in cooperation with the image forming apparatus 103. The image forming apparatus 103 serves as an MFP (multiple function peripheral). The image forming apparatus 103 comprises a scanner unit 104, an operation unit 105, an MFP controller 106, a printer unit (printer engine) 107, a fax unit 108, an IC (integrated circuit) card reader 109 and a finisher 110. Further, an external server 114 collects and manages device state information of the image forming apparatus 103.

<Constitution of Image Forming Apparatus>

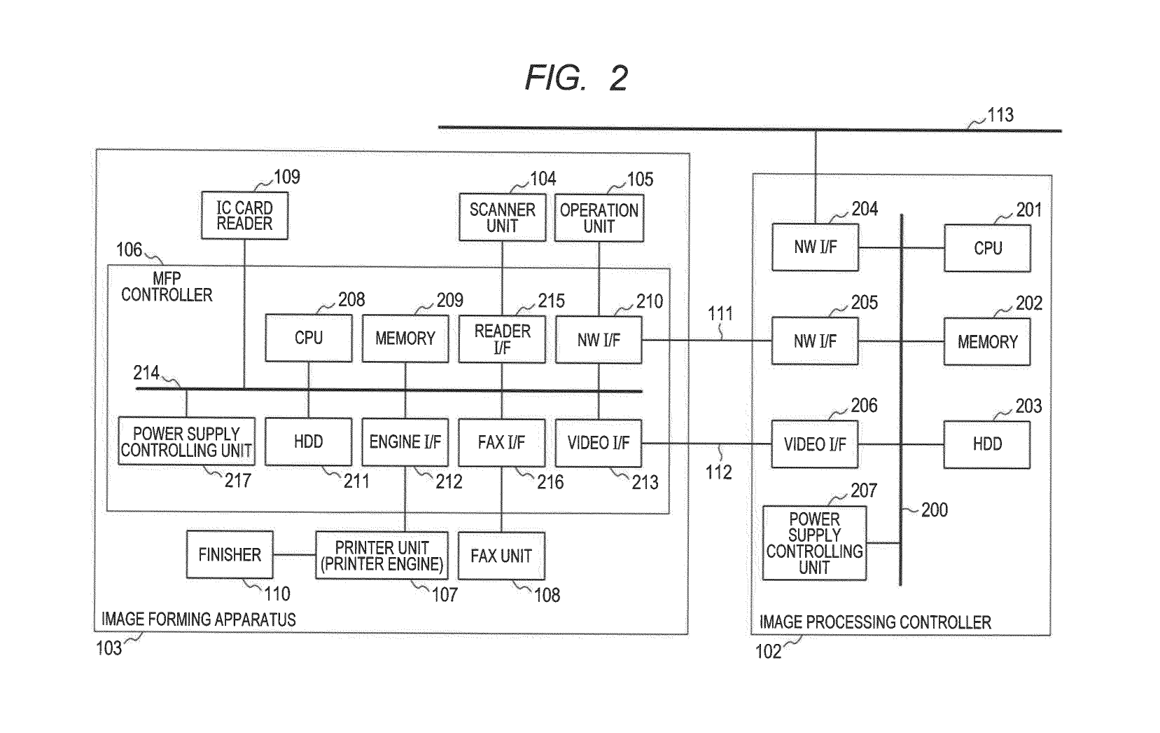

FIG. 2 is a block diagram illustrating an example of hardware constitutions of the image forming apparatus 103 and the image processing controller 102.

In the image forming apparatus 103, the scanner unit 104 reads an original image and thus inputs image data corresponding to the read original image. The operation unit 105 is equipped with various keys and panels. Here, the operation unit 105 accepts various instructions from a user through the various keys, and the operation unit 105 further displays various kinds information through the panels.

The MFP controller 106 controls the scanner unit 104, the printer unit 107 and the like. The detail of the MFP controller 106 will be described later. The printer unit 107 performs printing to a paper (or a sheet) based on the image data. The fax unit 108, which is connected to a not-illustrated telephone line, performs input and output processes of fax data through the telephone line or the like. The IC card reader 109 reads information from an IC card to be used for discriminating a user. The finisher 110 receives the papers on which the images were formed respectively by the printing unit 107, and performs various finishing processes such as paper discharging, sorting, stapling, punching, cutting and the like to the received papers.

The image forming apparatus 103 having the above constitution can execute a copying function, a “SEND” function, a “BOX” function, a printing function and the like.

Here, the copying function is the function to record the image data of the original image read by the scanner unit 104 in an HDD (hard disk drive) 211 and also cause the printer unit 107 to perform the printing to the paper based on the image data. The “SEND” function is the function to send or transmit the image data of the original image read by the scanner unit 104 to the client computer 101 through the network. The “BOX” function is the function to record image data transmitted from the client computer 101 in the HDD 211. The printing function is the function to cause the printer unit 107 to interpret and print PDL (page description language) data transmitted from the client computer 101.

<Detail of MFP Controller of Image Forming Apparatus>

Subsequently, the detail of the MFP controller 106 of the image forming apparatus 103 will be described.

As illustrated in FIG. 2, the MFP controller 106 of the image forming apparatus 103 comprises a CPU (central processing unit) 208, a memory 209, an NW I/F (network interface) 210, the HDD 211, an engine I/F (interface) 212, a video I/F 213, a reader I/F 215, a fax I/F 216 and a power supply controlling unit 217.

More specifically, the CPU 208 controls the respective parts of the image forming apparatus 103, performs calculations, and executes programs stored in the storage devices (i.e., the memory 209 and the HDD 211), through a system bus 214. The memory 209 is used as the working memory for the CPU 208. The NW I/F 210 transmits/receives control commands to/from the image processing controller 102 through the control cable 111. The HDD 211, which serves as the large-capacity storage device, stores therein various controlling programs to be executed by the CPU 208, and the image data.

The engine I/F 212 transmits/receives control commands to/from the printer unit 107. The video I/F 213 transits/receives the image data to/from the image processing controller 102 through the image video cable 112. The reader I/F 215 transmits/receives control commands to/from the scanner unit 104 and the operation unit 105. The fax I/F 216 is connected to the fax unit 108. The power supply controlling unit 217 controls power supply to the respective parts of the image forming apparatus 103.

<Detail of Image Processing Controller>

Besides, as illustrated in FIG. 2, the image processing controller 102 comprises a CPU 201, a memory 202, an HDD 203, NW I/Fs 204 and 205, a video I/F 206 and a power supply controlling unit 207.

More specifically, the CPU 201 controls the respective parts of the image processing controller 102, performs calculations, and executes programs stored in the storage devices (i.e., the memory 202 and the HDD 203), through a system bus 200. The memory 202 is used as the working memory for the CPU 201. The HDD 203, which serves as the large-capacity storage device, stores therein various controlling programs to be executed by the CPU 201, and the image data.

The NW I/F 204 performs communication with another device such as the client computer 101 or the like through the LAN 113. Besides, the NW I/F 205 transmits/receives control commands to/from the image forming apparatus 103 through the control cable 111. The video I/F 206 transmits/receives image data to/from the image forming apparatus 103 through the image video cable 112. The power supply controlling unit 207 controls power supply to the respective parts of the image processing controller 102.

<Power Supply Circuit Constitution of Image Forming Apparatus>

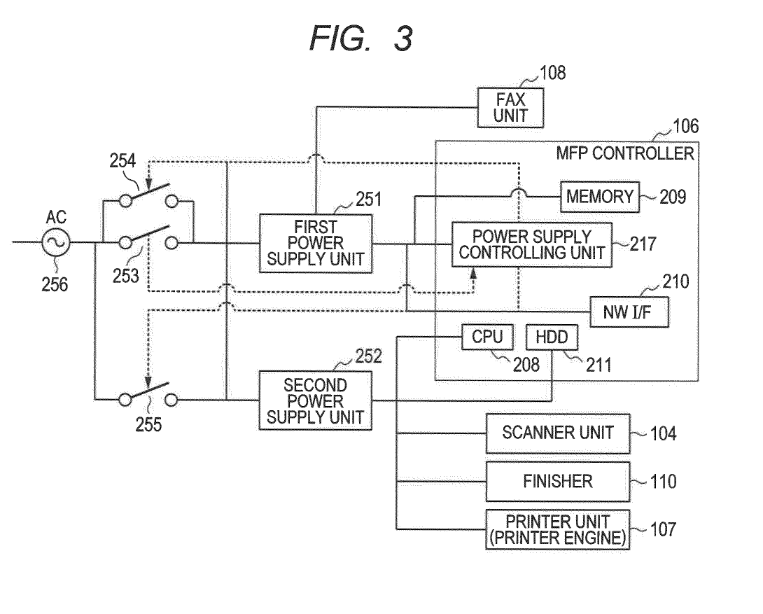

Subsequently, the power supply circuit constitution of the image forming apparatus 103 will be described with reference to FIG. 3.

Namely, FIG. 3 is the diagram illustrating an example of the power supply circuit constitution of the image forming apparatus 103.

The image forming apparatus 103 comprises a small-capacity first power supply unit 251 and a large-capacity second power supply unit 252. The first power supply unit 251 converts AC (alternating-current) power supplied from an AC power supply 256 into DC (direct-current) power (e.g., 3.3V). The obtained DC power is supplied to the fax unit 108, the power supply controlling unit 217, the memory 209, the NW I/F 210 and the like. Moreover, the second power supply unit 252 converts AC power supplied from the AC power supply 256 into DC power (e.g., 12V, 24V). The obtained DC power is supplied to the printer unit 107, the scanner unit 104, the finisher 110, the CPU 208, the HDD 211 and the like.

A seesaw switch 253 and a relay 254 are provided between the AC power supply 256 and the first power supply unit 251, and a relay 255 is provided between the AC power supply 256 and the second power supply unit 252. The seesaw switch 253 is brought into an on state or an off state according to an operation by a user, and the state (i.e., the on state or the off state) of the seesaw switch 253 is notified to the later-described power supply controlling unit 217.

The power supply controlling unit 217 detects the state (i.e., the on state or the off state) of the seesaw switch 253, and each of the relays 254 and 255 is switched between on and off in response to a control signal transferred from the power supply controlling unit 217. The power supply controlling unit 217 brings the relay 254 and the relay 255 into the on state respectively in accordance with the state of the seesaw switch 253, an instruction from the NW I/F 210, and the like. Thus, the power is supplied from the first power supply unit 251 and the second power supply unit 252 to the respective parts such as the printer unit 107, the scanner unit 104, the finisher 110 and the like, so that the image forming apparatus 103 shifts to a standby state.

Further, the power supply controlling unit 217 brings the relay 254 into the on state and also brings the relay 255 into the off state, in response to an instruction from the CPU 208 or the like. Thus, the power supply from the second power supply unit 252 to the printer unit 107, the scanner unit 104 and the like is stopped, so that the image forming apparatus 103 shifts to a power saving state. In the power saving state, the power supply to the limited parts such as the power supply controlling unit 217, the memory 209 and the NW I/F 210 is performed, whereas the power supply to other parts is stopped.

<Power Supply Circuit Constitution of Image Processing Controller>

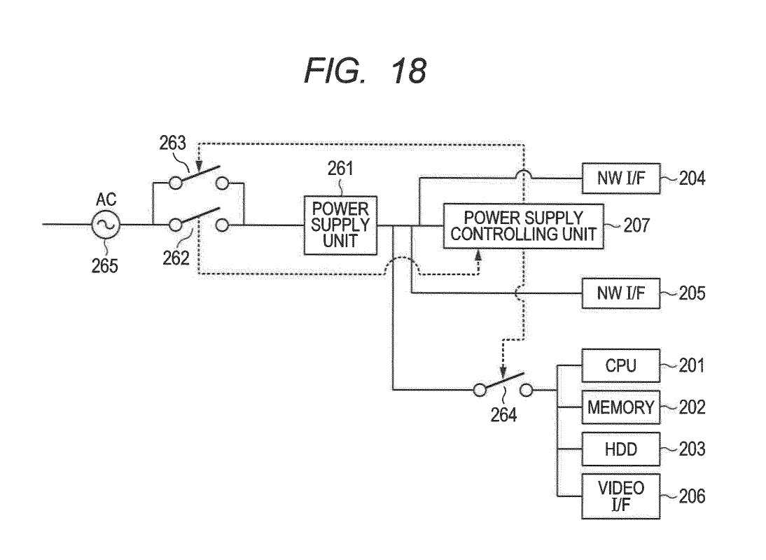

Subsequently, the power supply circuit constitution of the image processing controller 102 will be described with reference to FIG. 18. Namely, FIG. 18 is the diagram illustrating an example of the power supply circuit constitution of the image processing controller 102.

The image processing controller 102 comprises a power supply unit 261. The power supply unit 261 converts AC power supplied from an AC power supply 265 into DC power. The obtained DC power is supplied to the power supply controlling unit 207, the NW I/Fs 204 and 205, the CPU 201, the memory 202, the HDD 203, the video I/F 206 and the like.

A power supply switch 262 and a relay 263 are provided between the AC power supply 265 and the power supply unit 261, and a relay 264 is provided between the power supply unit 261 and a group of the CPU 201, the memory 202, the HDD 203 and the video I/F 206.

The power supply switch 262 is brought into an on state or an off state according to an operation by the user, and the state (i.e., the on state or the off state) of the power supply switch 262 is notified to the later-described power supply controlling unit 207. The power supply controlling unit 207 detects the state (i.e., the on state or the off state) of the power supply switch 262, and each of the relays 263 and 264 is switched between on and off by the power supply controlling unit 207.

The power supply controlling unit 207 respectively brings the relay 263 and the relay 264 into the on state in accordance with the state of the power supply switch 262, and instructions from the NW I/Fs 204 and 205. Thus, the power is supplied from the power supply unit 261 to the respective parts such as the CPU 201, the memory 202, the HDD 203, the video I/F 206 and the like, so that the image processing controller 102 shifts to a standby state.

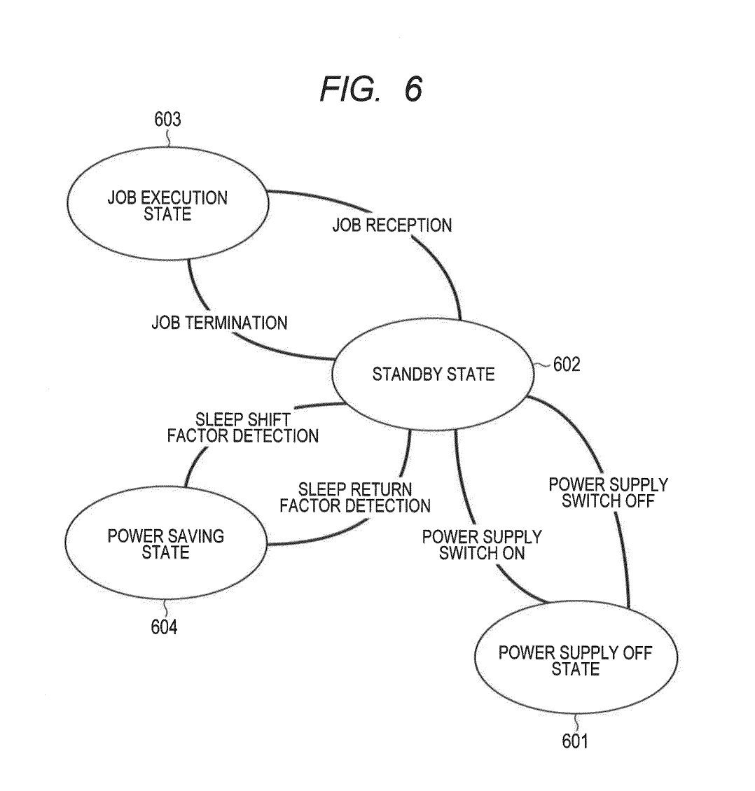

Further, the power supply controlling unit 207 brings the relay 263 into the on state and also brings the relay 264 into the off state, in response to an instruction from the CPU 201 or the like. Thus, the power supply from the power supply unit 261 to the group of the CPU 201, the memory 202, the HDD 203 and the video I/F 206 is stopped, so that the image processing controller 102 shifts to a power saving state 604 (FIG. 6). In the power saving state, the image processing controller 102 performs the power supply to the limited parts such as the power supply controlling unit 207, the NW I/Fs 204 and 205, and the like, whereas stops the power supply to the remaining parts.

<Block Diagram of NW I/F>

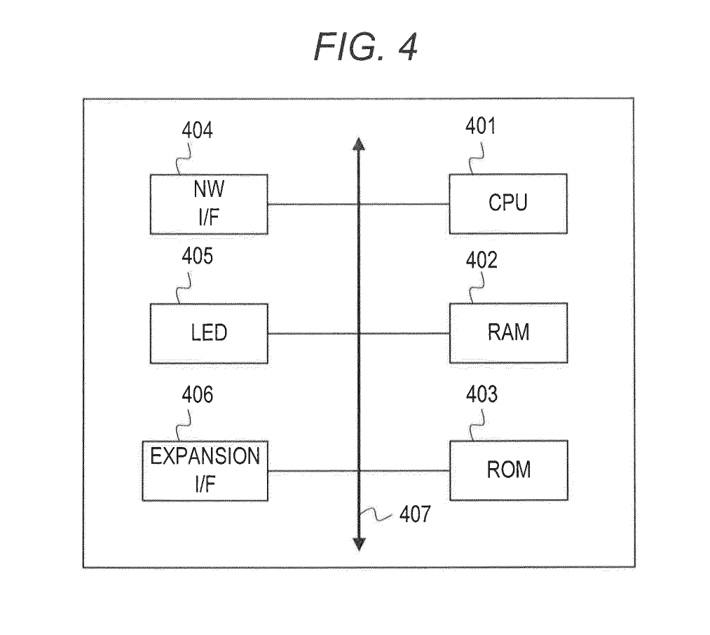

FIG. 4 is a block diagram illustrating an example of the hardware constitution of each of the NW I/Fs 204, 205 and 210. Incidentally, the NW I/Fs 204 and 205 are the detachable network interface devices of the image processing controller 102, and the NW I/F 210 is the detachable network interface device of the image forming apparatus 103.

As illustrated in FIG. 4, each of the NW I/Fs 204, 205 and 210 comprises a CPU 401, a RAM (random access memory) 402, a ROM (read-only memory) 403, an NW I/F 404, an LED (light-emitting diode) 405, an expansion I/F 406, and a system bus 407 for mutually connecting them with others.

The CPU 401 performs various controlling processes according to controlling programs stored in the ROM 403. For example, the CPU 401 connects itself to the LAN 113 through the NW I/F 404 connected to the system bus 407. Further, the CPU 401 performs communication with the client computer 101 on the LAN 113 according to a predetermined communication protocol. Thus, for example, the CPU 401 receives various data such as printing data, a printing control command and the like transmitted from the client computer 101, and transfers the received data to an expansion I/F in the image processing controller 102 through the expansion I/F 406, so that the image processing controller 102 can perform the image process.

The RAM 402 is used as a temporary storage area such as the main memory, the working area or the like of the CPU 401. The LED 405 is used as a displaying unit for displaying operation states of each of the NW I/Fs 204, 205 and 210. The LED 405 can display various operation states such as the electrical connection state between the NW I/F 404 and the LAN 113, a communication mode and the like, by means of colors and flashing patterns.

The expansion I/F 406, which is the I/F (interface) for connecting the NW I/F 210 and the image forming apparatus 103, or the NW I/Fs 204 and 205 and the image processing controller 102, is connected to, e.g., a PCI (Peripheral Component Interconnect) bus or the like.

<Software Configuration of Image Processing Controller>

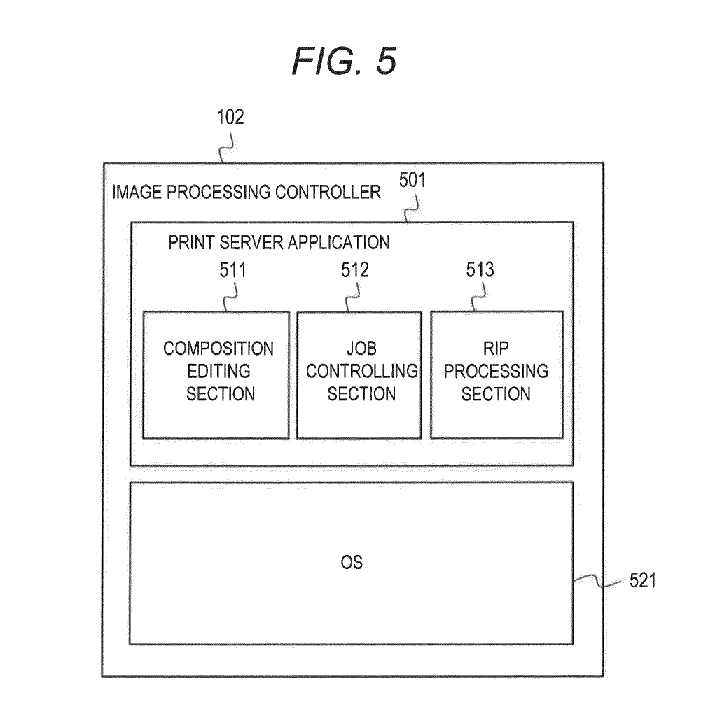

Subsequently, a software configuration of the image processing controller 102 will be described with reference to FIG. 5. Namely, FIG. 5 is the block diagram illustrating an example of the software configuration of the image processing controller 102. Incidentally, the function of the software illustrated in FIG. 5 is achieved on the condition that the CPU 201 reads and executes the program stored in the memory 202 or the HDD 203 of the image processing controller 102.

An OS (operating system) 521 is the basic software of the image processing controller 102. A print server application 501 is the application software which operates on the OS 521 executed by the CPU 201. More specifically, the print server application 501, which comprises a composition editing section 511, a job controlling section 512 and an RIP (raster image processor) processing section 513, performs various predetermined processes including the image process.

The composition editing section 511 is the editing section which performs a composition editing process for editing the image data of each page into a bookbinding composition format in response to an instruction from the client computer 101. The job controlling section 512 is the controlling section which controls a printing job in response to an instruction from the client computer 101. More specifically, the job controlling section 512 controls the reception of the printing data from the client computer 101, the instructions of the reception, the printing order in the printing job, and the like.

The RIP processing section 513 is the processing section which converts the PDL data into a printable raster image in the composition editing process by the compositing editing section 511 or the actual image forming process in the job controlling section 512.

<Power State Shifts of Image Processing Controller 102 and Image Forming Apparatus 103>

FIG. 6 is the diagram for describing power state shifts (or power state transitions) of the image processing controller 102 and the image forming apparatus 103.

Each of the image processing controller 102 and the image forming apparatus 103 according to the present embodiment shifts to any of a power supply off state 601, a standby state 602, a job execution state 603 and the power saving state 604. Although the above four states are exemplarily described in the present embodiment, the present invention is not limited to these states. Namely, each of the image processing controller 102 and the image forming apparatus 103 may shift to another power state.

For example, the image processing controller 102 may shift to a suspend state or a hibernation stat. Here, the suspend state is the state that the image processing controller 102 can return to the standby state 602 at high speed. In the suspend state, electric conduction to the memory 202 is maintained, and the image processing controller 102 shifts to the standby state 602 by using the state of the image processing controller 102 stored in the memory 202.

Also, the hibernation state is the state that the image processing controller 102 can return to the standby state at high speed. In the hibernation state, the power state is the same as the power supply off state 601, and thus power supply to the respective parts of the image processing controller 102 is stopped. However, the hibernation state is different from the power supply off state 601 in the point that the state of the image processing controller 102 is stored in the HDD 203 before the image processing controller shifts to the hibernation state. In any case, the image processing controller 102 returns from the hibernation state to the standby state at high speed on the basis of the information stored in the HDD 203.

If the power states of the image processing controller 102 and the image forming apparatus 103 are arranged in descending order of consumed power, the relation of the job execution state 603>the standby state 602>the power saving state 604>the power supply off state 601 is obtained.

First, the power states of the image forming apparatus 103 will be described hereinafter.

The power supply off state 601 is the state that the seesaw switch 253 (FIG. 3) of the image forming apparatus 103 is off, and, in this state, the power supply to all the parts of the image forming apparatus 103 is stopped. In the power supply off state 601, if the user turns on the seesaw switch 253, the image forming apparatus shifts to the standby state 602.

The standby state 602 is the state that the image forming apparatus 103 is on standby for job execution, and, in this state, the power supply to all the parts of the image forming apparatus 103 is performed. Incidentally, in the standby state 602, it is unnecessary to perform the power supply to all the parts of the image forming apparatus 103. Namely, it is possible to perform the power supply only to the necessary parts but not to perform the power supply to other parts (e.g., the operation unit 105 or the like). In the standby state 602, if a job is accepted from the client computer 101 through the image processing controller 102, then the image forming apparatus 103 shifts to the job execution state 603.

Moreover, in the standby state 602, if a power saving shift factor occurs (that is, if a power saving shift condition by which the apparatus shifts to the power saving state is satisfied), the image forming apparatus 103 shifts to the power saving state 604. Here, the power saving shift factor includes “A user depresses a power saving shift button (not illustrated).”, “A predetermined time elapses in a state that a printing job, a scanning job or the like is not executed in the standby state 602.”, “A predetermined time elapses in a state that a remote UI (user interface) of the image forming apparatus 103 is not accessed from the client computer 101.”, or the like. Besides, in the standby state 602, if the seesaw switch 253 is turned off by the user, a shutdown process is performed, so that the image forming apparatus 103 shifts to the power supply off state 601. Here, the shutdown process is the process for terminating the OS process or the application to terminate the operation of the image forming apparatus 103.

The job execution state 603 is the state that the image forming apparatus 103 is executing a job, and, in this state, the power supply to all the parts of the image forming apparatus 103 is performed. Incidentally, even in the job execution state 603, it is unnecessary to perform the power supply to all the parts of the image forming apparatus 103. That is, it is possible to perform the power supply only to the necessary parts but not to perform the power supply to other parts (e.g., the operation unit 105 or the like). Moreover, it is possible not to perform power supply to the parts not used for executing the job. More specifically, in a case where the printing job for forming an image on a paper is being executed, it is possible to stop the power supply to the operation unit 105, the scanner unit 104 and the like which are not used for executing the printing job. In the job execution state 603, if the job is terminated, the apparatus shifts to the standby state 602.

The power saving state 604 is the state that the image forming apparatus 103 is on standby with saved power, and, in this state, the power supply is performed to the partial constitution of the MFP controller 106 including the NW I/F 210 in the image forming apparatus 103. In the power saving state 604, the power supply to the scanner unit 104, the printer unit 107 and the operation unit 105 is stopped. In the power saving state 604, if a power saving return factor is accepted (that is, if a power saving return condition by which the apparatus returns from the power saving state is satisfied), the apparatus shifts to the standby state 602.

Incidentally, the NW I/F 210 can respond to a simple packet transmitted through the network, even in the power saving state 604. Such a function is called a proxy response. Here, the simple packet includes an ARP (Address Resolution Protocol) request, SNMP (Simple Network Management Protocol) state obtainment, an ICMP (Internet Control Message Protocol) neighboring search, or the like. Incidentally, the power saving return factor includes “A user depresses a power saving return button.”, “A job is accepted from the client computer 101.”, or the like.

Subsequently, the power states of the image processing controller 102 will be described.

The power supply off state 601 is the state that the OS of the image processing controller 102 is being shut down. In the power supply off state 601, if the user turns on the power supply switch 262 (FIG. 3), the image processing controller shifts to the standby state 602.

The standby state 602 is the state that the image processing controller 102 is on standby for job execution, and, in this state, the power supply to all the parts of the image processing controller 102 is performed. Incidentally, in the standby state 602, if a printing job is accepted from the client computer 101, the image processing controller 102 shifts to the job execution state 603. Moreover, in the standby state 602, if a power saving shift factor occurs (that is, if a power saving shift condition by which the image processing controller shifts to the power saving state is satisfied), the image processing controller 102 shifts to the power saving state 604. Here, the power saving shift factor includes “A user instructs to shift to the power saving state.”, “A predetermined time elapses in a state that a printing job, a scanning job or the like is not executed in the standby state 602.”, “A predetermined time elapses in a state that a job management tool of the image processing controller 102 is not accessed from the client computer 101.”, or the like.

The job execution state 603 is the state that the image processing controller 102 is executing a job, and, in this state, the power supply to all the parts of the image processing controller 102 is performed. In the job execution state 603, if the job is terminated, the image processing controller shifts to the standby state 602.

The power saving state 604 is the state that the image processing controller 102 is on standby with saved power, and, in this state, the power supply is performed in regard to the NW I/Fs 204 and 205 and the power supply controlling unit 207 in the image processing controller 102. In the power saving state 604, if a power saving return factor is accepted (that is, if a power saving return condition by which the image processing controller returns from the power saving state is satisfied), the image processing controller shifts to the standby state 602. Here, the power saving return factor (or the power saving return condition) includes “A user depresses the power supply button of the image processing controller 102.”, “A job is accepted from the client computer 101 by the image processing controller 102.”, “A magic packet is accepted from the client computer 101 by the image processing controller 102”, or the like. Here, the magic packet is the network packet which has been specially coded to turn on a power supply of a device through a network.

<Operation of Image Processing Controller 102 to be Performed when Image Forming Apparatus 103 Transmits Network Packet to External Server 114>

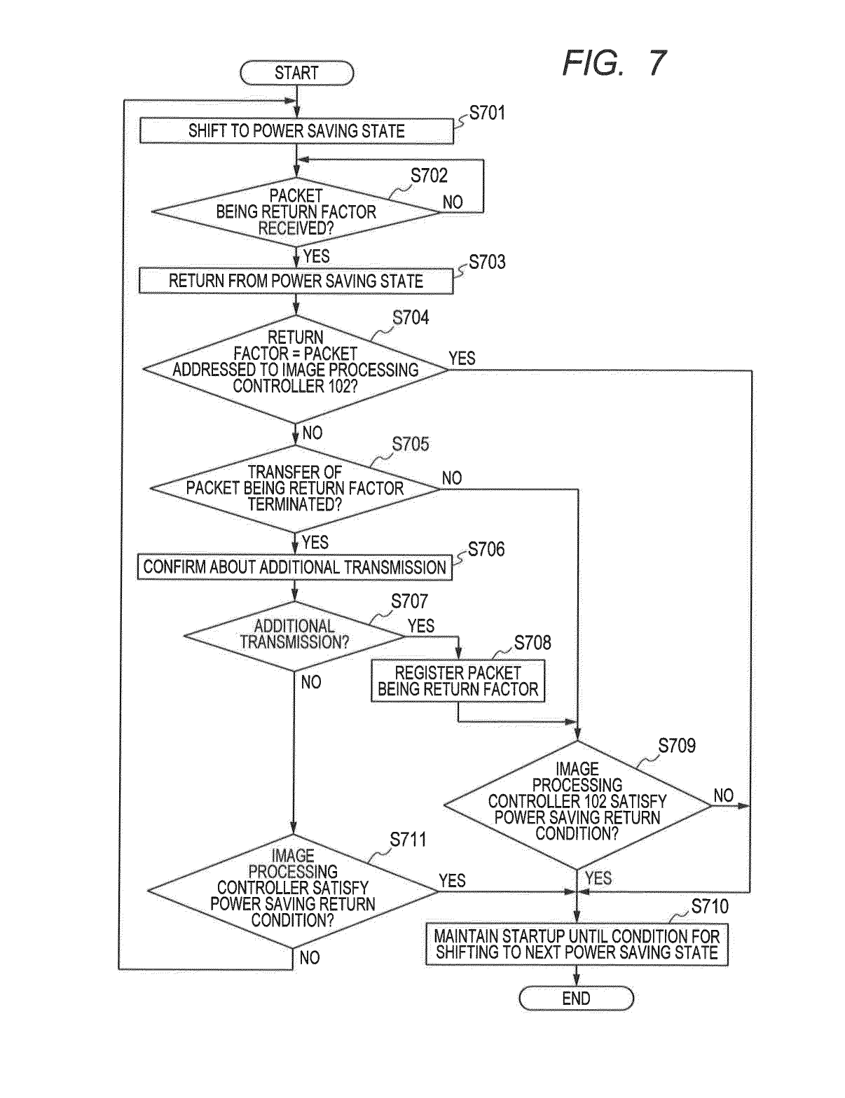

Hereinafter, an operation of the image processing controller 102 to be performed when the image forming apparatus 103 transmits a device status and scanning data to the external server 114 under the condition that both the image processing controller 102 and the image forming apparatus 103 are in the power saving state will be described with reference to a flow chart illustrated in FIG. 7.

FIG. 7 is the flow chart for describing an example of the operation of the image processing controller 102 according to the first embodiment. Incidentally, it should be noted that each step illustrated in FIG. 7 is achieved on the condition that the CPU 201 executes the program decompressed and expanded in the memory 202, or on the condition that the CPU 401 executes the program decompressed and expanded in the memory 402 or 403.

If the CPU 201 of the image processing controller 102 determines that the power saving shift condition of the image processing controller 102 is completely satisfied, the process advances to S701 to shift the image processing controller 102 to the power saving state. If the image processing controller 102 shifts to the power saving state, the power is supplied only to the NW I/Fs 204 and 205 and the minimum units. Thus, the power supply is not performed to the CPU 201, and the process advances to S702. Incidentally, the process in S702 is performed by the CPU 401 of each of the NW I/Fs 204 and 205. Although the CPU 401 is provided in each of the NW I/Fs 204 and 205, such two CPUs will be simply described as the CPU 401.

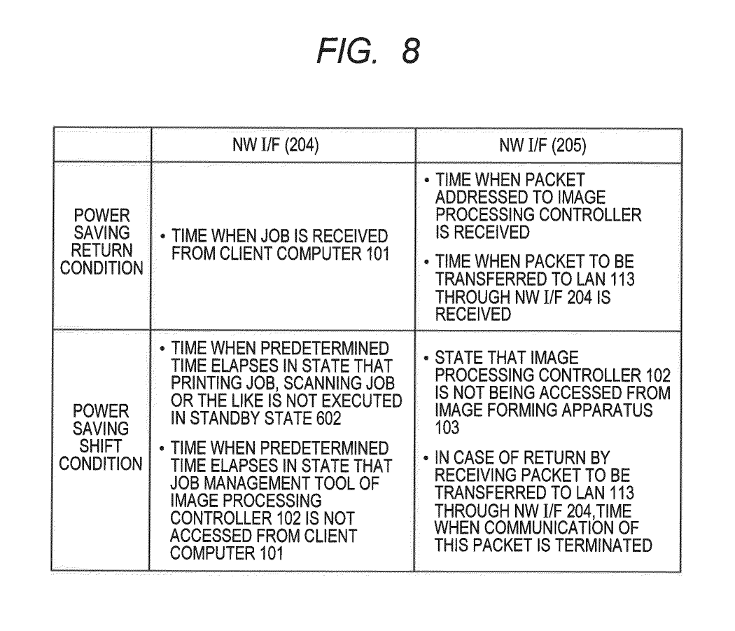

If the network packet reaching each of the NW I/Fs 204 and 205 is received, the CPU 401 of each of the NW I/Fs 204 and 205 determines whether or not the received packet is the packet of the pattern by which the image processing controller 102 returns from the power saving state. Here, the packet of the pattern by which the image processing controller returns from the power saving state is illustrated in FIG. 8.

FIG. 8 is the diagram illustrating the power saving return conditions and the power saving shift conditions respectively concerning the NW I/Fs 204 and 205 according to the first embodiment. Incidentally, the power saving return condition is the transition condition for returning from the power saving state to the standby state (604→602), and the power saving shift condition is the transition condition for shifting from the standby state to the power saving state (602→604).

Here, it should be noted that the transition conditions (i.e., the power saving return conditions and the power saving shift conditions) from the NW I/Fs 204 and 205 are mutually different from each other.

The power saving return condition from the NW I/F 204 corresponds to, for example, “TIME WHEN JOB IS RECEIVED FROM CLIENT COMPUTER 101” as shown in FIG. 8. Moreover, the power saving shift condition from the NW I/F 204 corresponds to, for example, “TIME WHEN PREDETERMINED TIME ELAPSES IN STATE THAT PRINTING JOB, SCANNING JOB OR THE LIKE IS NOT EXECUTED IN STANDBY STATE 602”, or “TIME WHEN PREDETERMINED TIME ELAPSES IN STATE THAT JOB MANAGEMENT TOOL OF IMAGE PROCESSING CONTROLLER 102 IS NOT ACCESSED FROM CLIENT COMPUTER 101” as shown in FIG. 8.

The power saving return condition from the NW I/F 205 corresponds to the two conditions as shown in FIG. 8. That is, the one condition is “TIME WHEN PACKET ADDRESSED TO IMAGE PROCESSING CONTROLLER IS RECEIVED (that is, the time when the image forming apparatus 103 transmits the network packet addressed to the image processing controller 102 and the image processing controller 102 receives the transmitted network packet)”, and the other condition is “TIME WHEN PACKET TO BE TRANSFERRED TO LAN 113 THROUGH NW I/F 204 IS RECEIVED (that is, the time when the image forming apparatus 103 transmits the packet to the destination (e.g., the external server 114) through the LAN 113 and the image processing controller 102 receives the transmitted packet)”. The image processing controller 102 receives the packet by the NW I/F 205, and then transfers, by the NW I/F 204, the received packet to the destination through the LAN 113. That is, the other condition (i.e., the second condition) corresponds to the case where the packet is received from the image forming apparatus 103 and the received packet is the packet addressed to another device (different from the image processing controller 102) through the LAN 113.

Besides, as illustrated in FIG. 8, the power saving shift condition from the NW I/F 205 corresponds to the two conditions. That is, the one condition is “STATE THAT IMAGE PROCESSING CONTROLLER 102 IS NOT BEING ACCESSED FROM IMAGE FORMING APPARATUS 103”, and the other condition is “IN CASE OF RETURN BY RECEIVING PACKET TO BE TRANSFERRED TO LAN 113 THROUGH NW I/F 204, TIME WHEN COMMUNICATION OF THIS PACKET IS TERMINATED (that is, in the case where the image forming apparatus 103 returns by receiving the packet transmitted to the destination (e.g., the external server 114) through the LAN 113, the time when the transfer of the packet to the LAN 113 is wholly completed)”.

The image processing controller 102 returns from the power saving state in the case where any one of the power saving return conditions from the NW I/F 204 and the NW I/F 205 corresponds. Further, the image processing controller 102 shifts to the power saving state in the case where all the power saving shift conditions of the NW I/F 204 and the NW I/F 205 are satisfied (except for a user's explicit power saving shift instruction).

The explanation is returned to S702. In S702, the CPU 401 determines whether or not the packet which is the power saving return factor (i.e., the packet which satisfies the power saving return condition) is received by the image processing controller 102, and such monitoring and determination are continued until the relevant packet is received. Then, if the CPU determines that the packet being the power saving return factor is received (YES in S702), then the process advances to S703.

In S703, the CPU 401 of the NW I/F of the image processing controller 102 which received the packet being the power saving return factor controls the power supply controlling unit 207 to supply the power to the CPU 201 and the like so as to return the image processing controller 102 from the power saving state. Then, if the image processing controller returns from the power saving state, the process advances to S704.

In S704, the CPU 201 determines whether or not the return factor is the packet addressed to the image processing controller 102. In the present embodiment, the determination as to whether or not the packet is addressed to the image processing controller 102 is performed based on determination as to whether or not destination IP (Internet Protocol) address information in an IP header indicates the address of the image processing controller 102.

If the CPU 201 determines in S704 that the return factor is the packet addressed to the image processing controller 102 (YES in S704), then the process advances to S710 because the return factor indicates the packet for normally starting the image processing controller 102.

In S710, the CPU 201 maintains the startup of the image processing controller 102 until the condition by which the image processing controller 102 shifts to a next power saving state is satisfied, and the entire process in the flow chart is terminated.

On the other hand, if the CPU 201 determines in S704 that the return factor is not the packet addressed to the image processing controller 102 (i.e., the packet addressed to another apparatus) (NO in S704), that is, if the return factor is the packet to be transferred to the LAN, then the process advances to S705.

In S705, the CPU 201 determines whether or not the transfer of the packet being the return factor is terminated. Namely, the period from a start of a series of sequences of the packet being the return factor to a termination of the series of sequences is the target of the packet transfer. As an example of the series of sequences, there is a case where, if a TCP (Transmission Control Protocol) packet is the return factor, the sequence from “SYN” to “FIN” of the TCP packet is monitored. Moreover, with respect to communication to be performed by multisession such as the FTP (File Transfer Protocol), a termination of all communications of the multisession is monitored. The termination of the packet is determined by a method of monitoring the communication in the image processing controller 102 based on the protocol of the packet being the return factor.

If the CPU 201 determines in S705 that the commination (transfer) of the packet being the return factor is not yet terminated (NO in S705), the process advances to S709. In S709, the CPU 201 determines whether or not the image processing controller 102 satisfies the power saving return condition.

If the CPU 201 determines in S709 that the image processing controller satisfies any of the power saving return conditions shown in FIG. 8 (YES in S709), then the process advances to S710. The description of the process in S710 and the subsequent step will be omitted because these processes were already described as above. On the other hand, if the CPU 201 determines in S709 that the image processing controller 102 does not satisfy the power saving return condition (NO in S709), the process returns to S704 and 5705 to again determine whether or not the transfer of the packet being the return factor is terminated.

Then, if the CPU 201 determines in S705 that the transfer of the packet being the return factor is terminated (YES in S705), the process advances to S706.

In S706, the CPU 201 confirms the image forming apparatus 103 as to whether or not the image forming apparatus 103 additionally transmits a packet. In a case where the image forming apparatus 103 next intends to perform another communication with the external server 114 on the LAN 113, if the image processing controller 102 shifts to the power saving state immediately after the termination of the previous communication, the image processing controller 102 returns from the power saving state immediately. For this reason, the CPU 201 of the image processing controller 102 previously confirms the image forming apparatus 103 as to whether or not there is an additional process. The CPU 201 confirms the image forming apparatus 103 as to whether or not the additional process is to be performed within a certain time, by an inquiry or the like to the image forming apparatus 103.

Next, in S707, the CPU 201 determines based on the confirmation result of S706 whether or not the image forming apparatus 103 additionally transmits the packet.

If the CPU 201 determines by a reply or the like from the image forming apparatus 103 that the additional transmission is performed (YES in S707), the process advances to S708. In S708, the CPU 201 adds the information concerning the additional transmission to the information concerning the packet being the return factor, and monitors the relevant packet. Then, the process advances to S709. The description of the process in S709 and the subsequent steps will be omitted because these processes were already described as above.

On the other hand, the CPU 201 determines in S707 that the additional transmission is not performed (NO in S707) if the reply indicating that any another communication is not performed to the external server 114 on the LAN 113 is sent from the image forming apparatus 103, and the process advances to S711. In S711, the CPU 201 determines whether or not the image processing controller 102 satisfies the power saving return condition.

Then, if the CPU 201 determines that the image processing controller satisfies any of the power saving return factor detection conditions shown in FIG. 8, the CPU determines that the power saving return condition is satisfied (YES in S711), and then the process advances to S710. The description of the process in S710 and the subsequent step will be omitted because these processes were already described as above.

On the other hand, if the CPU 201 determines that the image processing controller does not satisfy any of the power saving return factor detection conditions shown in FIG. 8, the CPU determines that the power saving return condition is not satisfied (NO in S711), and then the process returns to S701. The CPU 201 instructs the shift to the power saving, and the image processing controller 102 shifts to the power saving state. Incidentally, in the present embodiment, it is confirmed in S706 and 5707 whether or not there is the additional process in the image forming apparatus 103. However, it is assumed that the operation in which such confirmation (S706, S707, S708) is not performed is also included in the present invention.

<Operation of Image Forming Apparatus 103 to be Performed when Image Forming Apparatus 103 Transmits Network Packet to External Server 114>

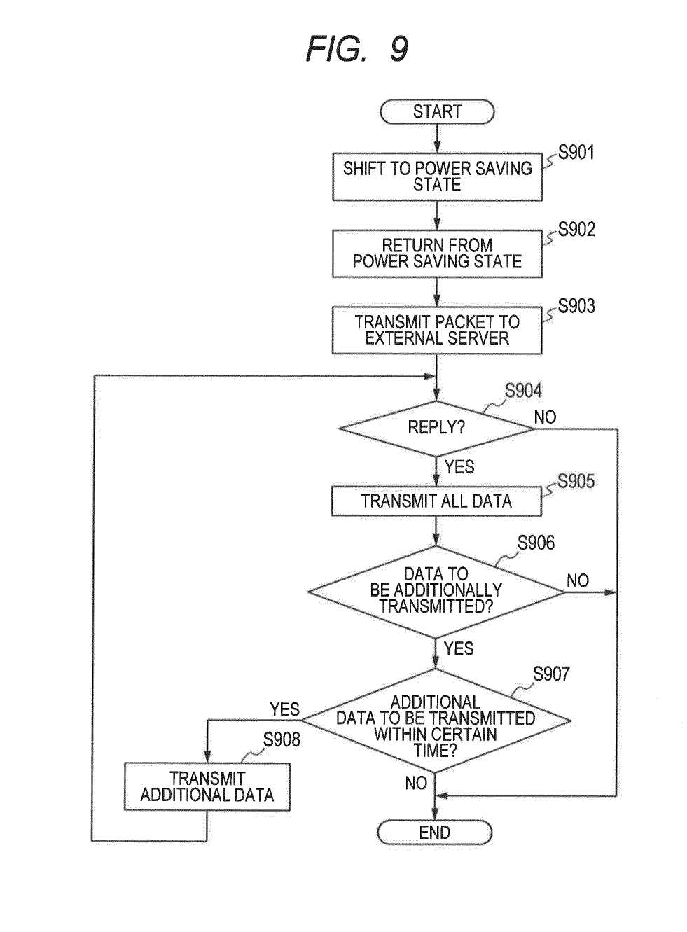

Subsequently, an operation of the image forming apparatus 103 to be performed when transmitting a device status and scanning data to the external server 114 under the condition that both the image processing controller 102 and the image forming apparatus 103 are in the power saving state will be described with reference to a flow chart illustrated in FIG. 9.

FIG. 9 is the flow chart for describing an example of the operation to be performed by the image forming apparatus 103 according to the first embodiment. Incidentally, it should be noted that each step illustrated in FIG. 9 is achieved on the condition that the CPU 208 executes the program decompressed and expanded in the memory 209.

If the CPU 208 of the image forming apparatus 103 makes the power saving shift state of the image forming apparatus 103 complete, the process advances to S901 to shift the image forming apparatus 103 to the power saving state. If the CPU 401 of the NW I/F 210 detects the return factor from the power saving state, the process advances to S902 to control to return the apparatus from the power saving state. After the apparatus returned from the power saving state, if the CPU 208 detects an instruction for transmitting the network packet to the external serer 114 by the operation of the operation unit 105 or the like, then the process advances to S903.

In S903, the CPU 208 transmits the network packet to the external server 114, and the process advances to S904.

In S904, the CPU 208 determines whether or not a reply is transmitted from the external server 114. If the NW I/F 210 is in the state capable of performing network communication and the CPU 208 determines that any reply is not transmitted from the external server 114 or the image processing controller 102 (NO in S904), then the CPU 208 terminates the entire process in the flow chart because it is impossible to normally communicate with the external server 114.

On the other hand, if the CPU 208 determines in S904 that the reply is transmitted from the external server 114 (YES in S904), the process advances to S905. In S905, the CPU 208 transmits all the data to the external server 114. Then, if the transmission of all the data is terminated, the process advances to S906.

In S906, the CPU 208 determines whether or not data to be additionally transmitted exists. Then, if the CPU determines that the data to be additionally transmitted does not exist (NO in S906), the CPU 208 notifies the image processing controller 102 of the termination of data communication (not illustrated), and the entire process in the flow chart is terminated.

On the other hand, if the CPU 208 determines in S906 that the data to be additionally transmitted exists (YES in S906), the process advances to S907. In S907, the CPU 208 determines whether or not information (data) to be additionally transmitted within a certain time exists. For example, in a case where the user instructs to transmit next data by the operation on the operation unit 105 while the image forming apparatus 103 is transmitting the previous job, or in a case where a job which includes timer setting for transmitting data at a certain time is detected, the CPU determines that the additional information to be transmitted within the certain time exists.

If the CPU 208 determines in S907 that the additional information to be transmitted within the certain time does not exist (NO in S907), then the CPU notifies the image processing controller 102 of the termination of data communication (not illustrated), and the entire process in the flow chart is terminated.

On the other hand, if the CPU 208 determines in S907 that the additional information to be transmitted within the certain time exists (YES in S907), then the CPU notifies the image processing controller 102 of such a fact (not illustrated), and the process advances to S908. For example, in a case where a job which includes timer setting for transmitting data within a certain time exists, the process advances to S908 at the relative certain time.

In S908, the CPU 208 transmits the additional information, and the process returns to S904 to again wait for the reply from the image processing controller 102. Incidentally, if NO in S907, the CPU 208 may notify the image processing controller 102 of the additional job transmission.

In the present embodiment, the operation of the image forming apparatus 103 to be performed when transmitting the device status and the scanning data to the external server 114 was exemplarily described as above. However, the present invention is not limited to the relevant operation. Namely, the present invention may be applied to any operation that the image forming apparatus 103 transmits data to the destination through the LAN 113. For example, the present invention may be applied to an operation that the image forming apparatus transmits data to another network through a not-illustrated router on the LAN 113.

As described above, in the present embodiment, by transmitting the packet to be transferred to the LAN from the image forming apparatus 103 to the image processing controller 102, it is possible to return the image processing controller 102 from the power saving state. Moreover, in the case where the image processing controller 102 returns from the power saving state by the packet to be transferred to the LAN, the image processing controller 102 can shift to the power saving state immediately after the termination of the transfer of the packet.

### Second Embodiment

The second embodiment is different from the above first embodiment in the point of the power saving return condition and the power saving shift condition by the NW I/F 205 of the image processing controller 102. In the first embodiment, even in the case where the packet received from the image forming apparatus 103 by the NW I/F 205 of the image processing controller 102 is not the packet addressed to the image processing controller itself (i.e., in the case of transferring the packet to the LAN), the image processing controller returns from the power saving state. On the other hand, in the second embodiment, the power saving return condition by the NW I/F 205 of the image processing controller 102 is only a case where a packet of a specific pattern is received from the image forming apparatus 103. Hereinafter, the present embodiment will be described in detail.

<Operation of Image Processing Controller 102 to be Performed when Image Forming Apparatus 103 Transmits Network Packet to External Server 114>

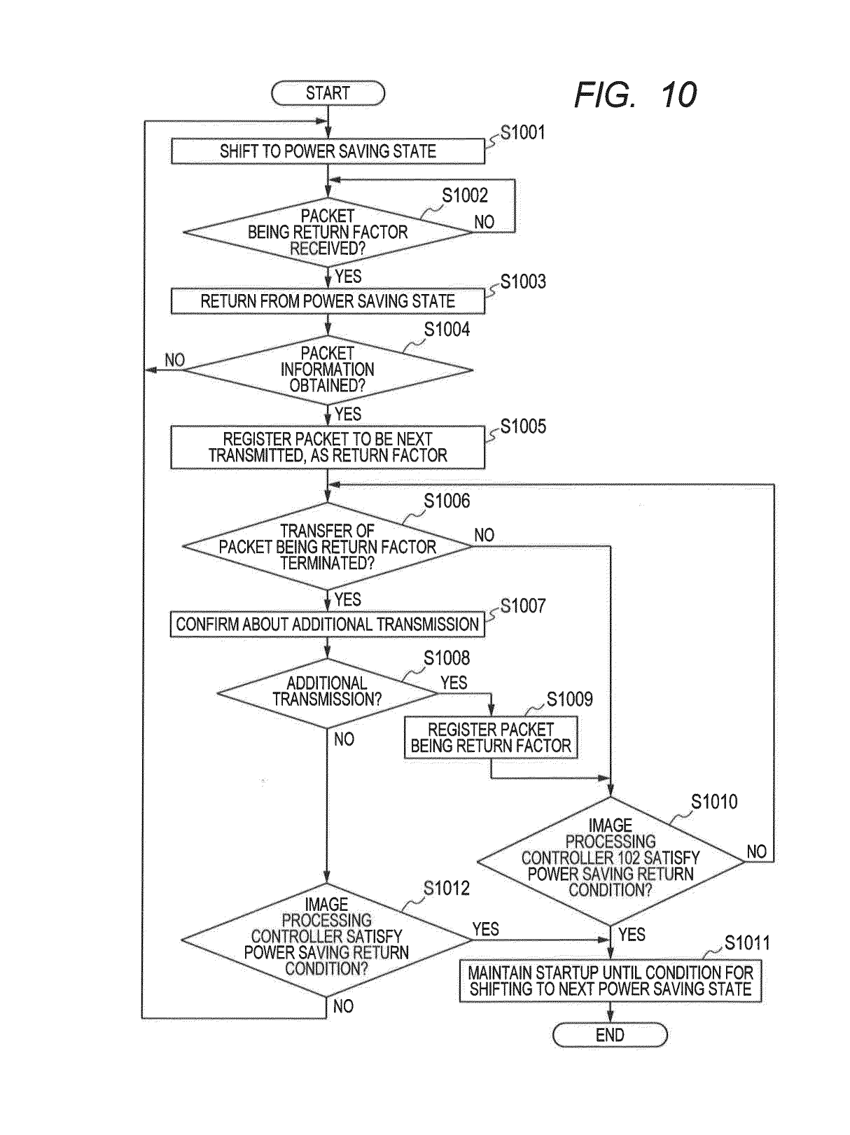

Hereinafter, an operation of the image processing controller 102 to be performed when the image forming apparatus 103 transmits a device status and scanning data to the external server 114 under the condition that both the image processing controller 102 and the image forming apparatus 103 are in the power saving state will be described with reference to a flow chart illustrated in FIG. 10.

FIG. 10 is the flow chart for describing an example of the operation to be performed by the image processing controller 102 according to the second embodiment. Incidentally, it should be noted that each step illustrated in FIG. 10 is achieved on the condition that the CPU 201 executes the program decompressed and expanded in the memory 202, or on the condition that the CPU 401 executes the program decompressed and expanded in the memory 402 or 403.

In the flow chart of FIG. 10, the description of the steps already described about the flow chart of FIG. 7 will be omitted, and only the portions different from the flow chart of FIG. 7 will be mainly described hereinafter. Initially, since the respective processes in S1001 to S1003 are the same as those in S701 to S703, the description thereof will be omitted. However, since the power saving return condition in S1002 is different from the condition in the first embodiment, the relevant condition will be described hereinafter.

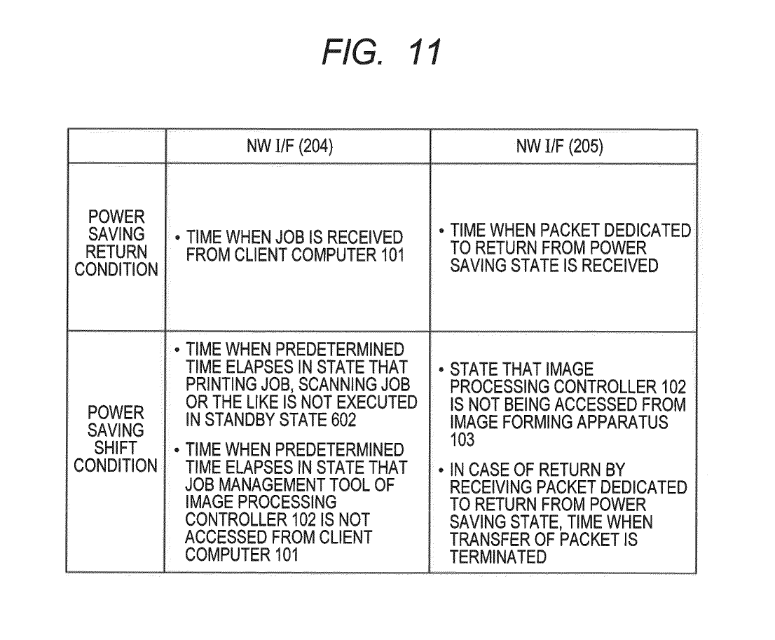

FIG. 11 is a diagram illustrating the power saving return conditions and the power saving shift conditions from the NW I/F 204 and the NW I/F 205 according to the second embodiment.

Since the power saving return condition and the power saving shift condition from the NW I/F 204 are the same as those in the first embodiment (FIG. 8), the description thereof will be omitted. However, these conditions may be made different from those in the first embodiment.

As illustrated in FIG. 11, the power saving return condition from the NW I/F 205 corresponds to the time when the image forming apparatus 103 transmits a specific packet necessary to return the image processing controller 102 from the power saving state. Although this packet will be described as a packet dedicated to return from the power saving state (i.e., a magic packet) in the present embodiment, this packet may merely be the packet addressed to the image processing controller 102 described in the first embodiment.

Moreover, the power saving return condition from the NW I/F 205 corresponds to the state that the image processing controller 102 is not being accessed from the image forming apparatus 103 and the case where the communication of the packet to be transmitted by the image forming apparatus 103 next to the packet by which the image processing controller 102 returns is terminated. Hereinafter, the process in S1004 will be described.

In S1004, the CPU 201 analyzes the packet received in S1002 and being the return factor, and determines whether or not information (packet information) of the network packet to be next transmitted by the image forming apparatus 103 is described in the analyzed packet. The network packet to be next transmitted by the image forming apparatus 103 corresponds to, for example, a process in which the user transmits data to the external server 114 by operating the operation unit 105 of the image forming apparatus 103. In this case, if the data transmitted by the image forming apparatus 103 is received, the image processing controller 102 has to transfer the received data to the external server 114. For this reason, it is necessary for the image processing controller 102 to obtain, in addition to the packet for return from the power saving state, the information of the network packet to be next transmitted by the image forming apparatus 103, and register the obtained information as the packet being the return factor. Besides, as another example of obtaining the information of the network packet to be next transmitted by the image forming apparatus 103, there may be a case of transmitting the information of the network packet to be next communicated by the image forming apparatus 103 by using another protocol, after the packet being the return factor.

In S1004 above, as the result that the CPU 201 analyzes the packet received in S1002 and being the return factor, if the information of the network packet to be next transmitted by the image forming apparatus 103 is described in the analyzed packet, the CPU 201 determines that the packet information can be obtained (YES in S1004), and the process advances to S1005.

In S1005, the CPU 201 registers the packet to be next transmitted by the image forming apparatus 103, as the return factor, and then the process advances to S1006. Incidentally, since the respective processes in S1006 to S1012 are the same as those in S705 to S711, the description thereof will be omitted.

Moreover, in S1004 above, as the result that the CPU 201 analyzes the packet received in S1002 and being the return factor, if the information of the network packet to be next transmitted by the image forming apparatus 103 is not described in the analyzed packet, the CPU 201 determines that the packet information cannot be obtained (NO in S1004), and the process returns to S1001 to again shift to the power saving state.

Incidentally, as another example, if NO in S1004, the process may advance to S1012 not to shift to the power saving state until a next power saving shift condition is satisfied.

<Operation of Image Forming Apparatus 103 to be Performed when Image Forming Apparatus 103 Obtains Setting Information of Image Processing Controller 102>

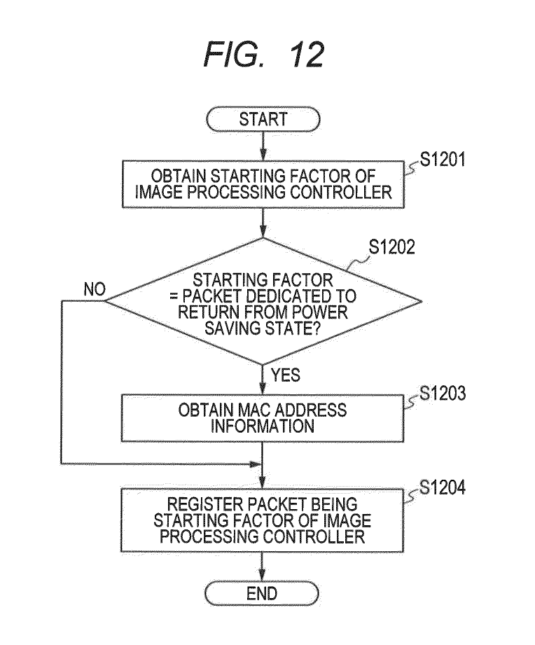

Next, an operation to be performed when the image forming apparatus 103 obtains setting information of the image processing controller 102 at the time of startup will be described with reference to FIG. 12.

FIG. 12 is the flow chart for describing an example of a setting information obtaining operation of the image forming apparatus 103 according to the second embodiment. Incidentally, it should be noted that each step illustrated in FIG. 12 is achieved on the condition that the CPU 208 executes the program decompressed and expanded in the memory 209.

If the image forming apparatus 103 is started, the CPU 208 starts the operation in S1201. In S1201, the CPU 208 obtains a power saving starting factor of the image processing controller 102. The CPU 208 transmits a packet for obtaining the power saving return condition of the NW I/F 205 of FIG. 11 to the image processing controller 102, and the image processing controller 102 returns such information. If the CPU 208 obtains in S1201 the return information from the image processing controller 102, the process advances to S1202.

In S1202, the CPU 208 determines whether or not the power saving return condition of the image processing controller 102 corresponds to the time when the packet dedicated to return from the power saving state (i.e., the magic packet) is received. Then, if the CPU 208 determines in S1202 that the power saving return condition of the image processing controller 102 corresponds to the time when the packet dedicated to return from the power saving state (the magic packet) is received (YES in S1202), the process advances to S1203.

In S1203, the CPU 208 obtains the MAC (media access control) address of the image processing controller 102. In the packet dedicated to return from the power saving state (the magic packet) according to the present embodiment, it is necessary to include the MAC address of the device which is returned from the power saving state, in the payload portion of the packet. For this reason, it is necessary to obtain the MAC address of the image forming apparatus 103. Incidentally, it is needless to say that the information obtained from the image forming apparatus 103 is changed by using, instead of the magic packet of the format according to the present embodiment, a magic packet of another format. Moreover, even if the information of the image forming apparatus 103 is not obtained, a magic packet capable of returning the image forming apparatus 103 from the power saving state may be used if the magic packet like this can be obtained. If the CPU 208 obtains the MAC address, the process advances to S1204. In this case, in S1204, the CPU 208 creates the packet for returning the image processing controller 102 on the basis of the information obtained from the image forming apparatus 103, and stores the created packet. Then, the entire process in the flow chart is terminated.

On the other hand, in S1202, if the CPU 208 determines that the power saving return condition of the image processing controller 102 does not correspond to the time when the magic packet is received (NO in S1202), the process advances to S1204. In this case, in S1204, the CPU 208 creates the packet on the basis of the information of the power saving return condition of the image processing controller 102, and stores the created packet. Then, the entire process in the flow chart is terminated.

<Operation of Image Forming Apparatus 103 to be Performed when Image Forming Apparatus 103 Transmits Network Packet to External Server 114>

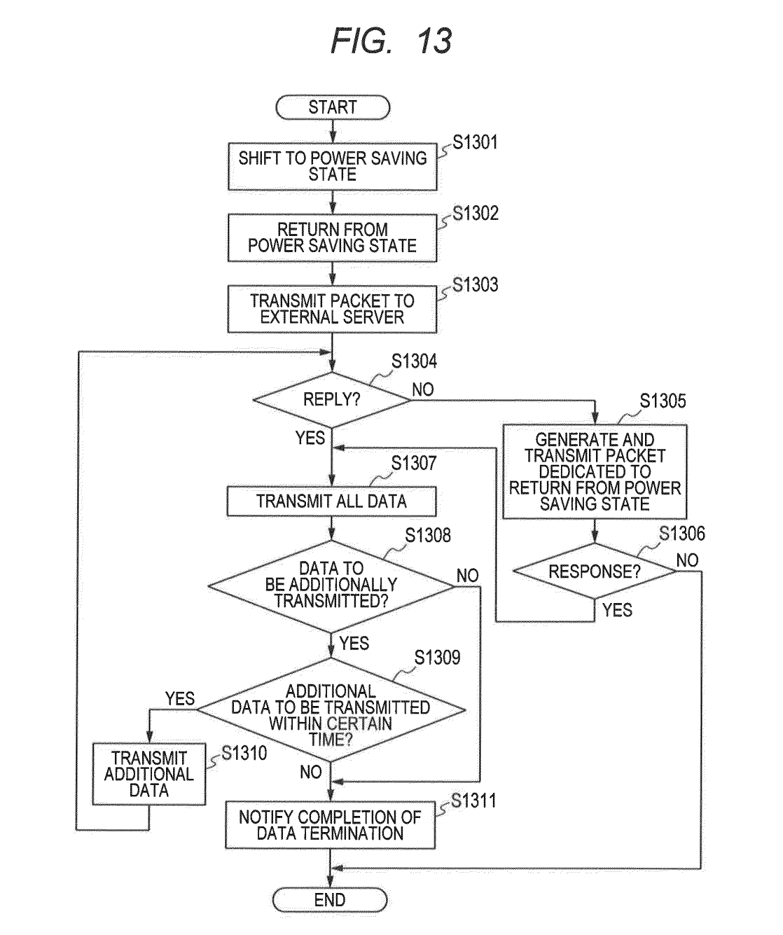

Subsequently, an operation of the image forming apparatus 103 to be performed when transmitting a device status and scanning data to the external server 114 under the condition that both the image processing controller 102 and the image forming apparatus 103 are in the power saving state will be described with reference to a flow chart illustrated in FIG. 13.

FIG. 13 is the flow chart for describing an example of the operation of the image forming apparatus 103 according to the second embodiment. Incidentally, it should be noted that each step illustrated in FIG. 13 is achieved on the condition that the CPU 208 executes the program decompressed and expanded in the memory 209.

In the flow chart of FIG. 13, the description of the steps already described about the flow chart of FIG. 9 will be omitted, and only the portions different from the flow chart of FIG. 9 will be mainly described hereinafter. Initially, since the respective processes in S1301 to S1304 are the same as those in S901 to S904, the description thereof will be omitted.

If the CPU 208 determines that there is no reply packet from the external server 114 (NO in S1304), the process advances to S1305.

In S1305, the CPU 208 transmits the packet dedicated to return from the power saving state (i.e., the magic packet) to the image forming apparatus 103 to return the image forming apparatus 103 from the power saving state. In this case, the MAC address of the image processing controller 102 and the information of the network packet to be next transmitted by the image forming apparatus 103 are stored in the payload portion of the packet dedicated to return from the power saving state (the magic packet), and then the relevant packet is transmitted. Incidentally, the network packet to be next transmitted by the image forming apparatus 103 may not be included in the magic packet but may be transmitted as another packet or by another protocol. If the CPU 208 transmits the magic packet to the image forming apparatus 103, the process advances to S1306.

In S1306, the CPU 208 waits for a response from the image forming apparatus 103. Then, if the CPU 208 determines that there is no response from the image forming apparatus 103 (NO in S1306), the entire process in the flow chart is terminated.

On the other hand, if the CPU 208 determines that there is the response from the image forming apparatus 103 (YES in S1306), the process advances to S1307. Incidentally, since the respective processes in S1307 to S1310 are the same as those in S905 to S908, the description thereof will be omitted. Then, if the CPU 208 terminates the transmission of all the data in S1309, the process advances to S1311. In S1311, the CPU 208 issues a data transmission termination notification, and the entire process in the flow chart is terminated.

As described above, according to the present embodiment, by transmitting the packet dedicated to return from the power saving state (the magic packet) from the image forming apparatus 103 to the image processing controller 102, it is possible to return the image processing controller 102 from the power saving state. Moreover, in the case where the image processing controller returns from the power saving state by the packet dedicated to return from the power saving state (the magic packet), the image processing controller 102 can shift to the power saving state immediately after the transfer of the packet from the image forming apparatus 103 was terminated.

### Third Embodiment

The third embodiment is different from the above second embodiment in the point that, when the image forming apparatus 103 returns the image processing controller 102 from the power saving state, the network packet information generated by the operation of the user is not notified on the image forming apparatus 103. In addition, the third embodiment is different from the second embodiment in the point that, in case of returning from the power saving state by the magic packet received by the NW I/F 205, the image processing controller 102 monitors the data communication based on a monitoring protocol condition (later described in detail) set by the user, and issues a notification of the termination of the data communication. The present embodiment will be described in detail.

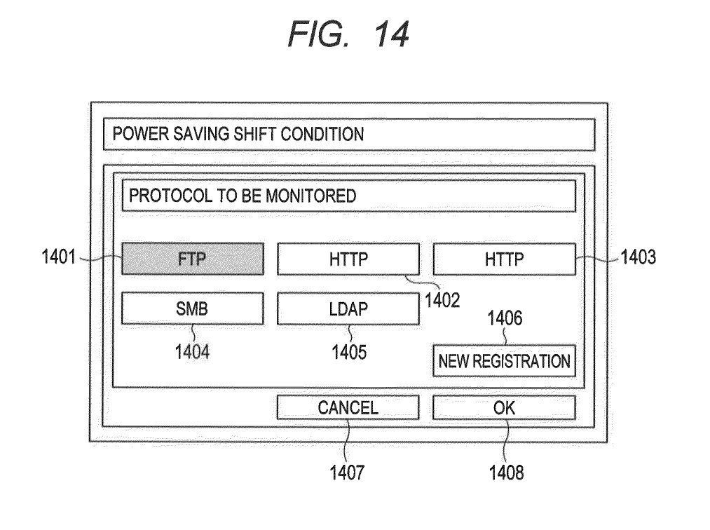

Hereinafter, a user interface of the screen for registering a protocol to be monitored in case of return of the image processing controller 102 from the power saving state will be described with reference to FIG. 14.

FIG. 14 is the diagram illustrating an example of the protocol to be monitored when the image processing controller 102 returns from the power saving state. Incidentally, this screen may be displayed on the monitor of the client computer 101 which accesses the image processing controller 102 or on the display of the operation unit 105 of the image forming apparatus 103.

In FIG. 14, buttons 1401 to 1405 respectively correspond to the protocols previously registered in the image processing controller 102. If the user selects, among these buttons, the button corresponding to the protocol that the user wishes to monitor and then depressed the selected button, then the button is highlighted, and the protocol of the highlighted button can be registered as the monitoring target. Then, if the same highlighted button is depressed, the highlight of the depressed button is returned, and the corresponding protocol can be removed from the monitoring target. In the third embodiment, the FTP button 1401 is selected as the monitoring target.

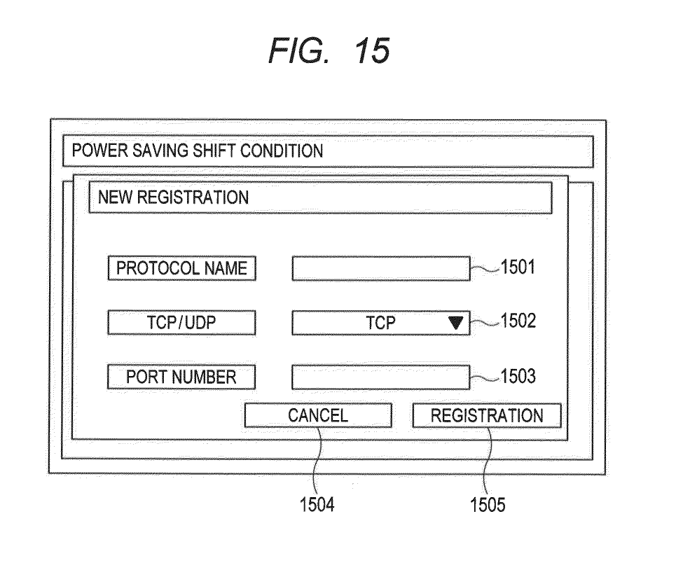

Moreover, if the user wishes to register a monitoring target protocol other than the previously registered set of the protocols (the buttons 1401 to 1405), he/she depresses a new registration button 1406. If the new registration button 1406 is depressed, the information corresponding to this button is notified to the image processing controller 102. Thus, the CPU 201 displays a new registration screen illustrated in FIG. 15.

FIG. 15 is the diagram illustrating an example of the screen for newly registering the protocol to be monitored when the image processing controller 102 returns from the power saving state. Incidentally, this screen may be displayed on the monitor of the client computer 101 which accesses the image processing controller 102 or on the display of the operation unit 105 of the image forming apparatus 103.

The information input to a protocol name section 1501 is used as the button name of a newly created button in FIG. 14. The TCP or the UDP (User Datagram Protocol) can be selected in a TCP/UDP section 1502, and the selected protocol is monitored. The port number of the TCP/UDP communication to be monitored is input to a port number section 1503. If the user wishes to stop new registration, he/she depresses a cancel button 1504. If the user performs new registration, he/she depresses a registration button 1505.

In the present embodiment, the TCP and the UDP are limitedly used as the protocols capable of being registered. However, another protocol such as the ICMP (Internet Control Message Protocol) or the like may be registered. Moreover, instead of the protocol to be monitored, a function of the image forming apparatus 103 may be registered. In this case, it is necessary for the image processing controller 102 to extract the communication protocol to be used from the function of the image forming apparatus 103. In any case, if either the cancel button 1504 or the registration button 1505 is depressed, the information of the depressed button is notified to the image processing controller 102, and the CPU 201 thus returns the screen to the screen illustrated in FIG. 14. Further, if the registration button 1505 is depressed, the registered button is displayed on the screen illustrated in FIG. 14 under the control of the CPU 201.

In FIG. 14, if a cancel button 1407 is depressed, the registration is cancelled. If a registration button 1408 is depressed, the change performed by the user is reflected. That is, the client computer 101 which accesses the image processing controller 102, or the image forming apparatus 103 transmits the monitoring protocol condition set on the screen illustrated in FIG. 14 to the image processing controller 102. The image processing controller 102, which received the monitoring protocol condition, stores the monitoring protocol condition in the HDD 203. Incidentally, another user interface such as a button for deleting a current button or the like may be provided on the screen illustrated in FIG. 14.

Moreover, in a case where the operation unit having the displaying screen is provided in the image processing controller 102, the screens illustrated in FIGS. 14 and 15 may be displayed on the display of the relevant operation unit, so that the user performs operations from the relevant operation unit.

<Operation Example in which Image Forming Apparatus 103 Obtains Setting Information of Image Processing Controller 102>

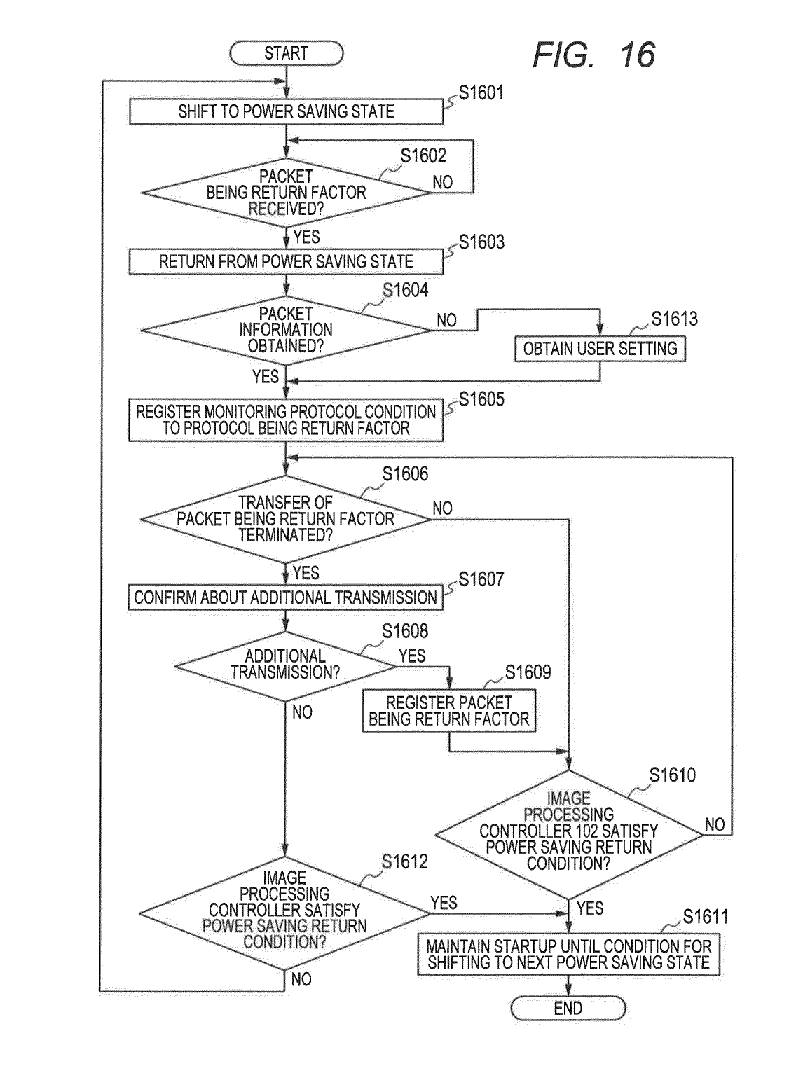

Hereinafter, an operation to be performed when the image forming apparatus 103 obtains a setting value of the image processing controller 102 at the time of startup of the image forming apparatus will be described with reference to FIG. 16.

FIG. 16 is the flow chart for describing an example of the operation of the image processing controller 102 according to the third embodiment. Incidentally, it should be noted that each step illustrated in FIG. 16 is achieved on the condition that the CPU 201 executes the program decompressed and expanded in the memory 202, or on the condition that the CPU 401 executes the program decompressed and expanded in the memory 402 or 403.

In the flow chart of FIG. 16, the description of the steps already described about the flow chart of FIG. 10 will be omitted, and only the portions different from the flow chart of FIG. 10 will be mainly described hereinafter. Initially, since the respective processes in S1601 to S1603 are the same as those in S1001 to S1003, the description thereof will be omitted.

In S1604, if the CPU 201 cannot obtain the information concerning the network data intended to be next transmitted, from the packet transmitted by the image forming apparatus 103, the process advances to S1613.

In S1613, the CPU 201 obtains the monitoring protocol condition set by the user. Namely, the CPU 201 obtains the monitoring protocol condition from the HDD 203, and the process advances to S1605. In this case, in S1605, the CPU 201 registers the monitoring protocol condition obtained in S1604 to the protocol being the return factor, and the process advances to S1606.

In S1606, since the CPU 201 cannot receive the transmission data termination notification from the image forming apparatus 103, if transmission of the packet being the return factor is not performed for a certain time, the CPU determines that the transmission by the image forming apparatus 103 is terminated (YES in S1606), and the process advances to S1607. Here, it is assumed that a previously set value in the image processing controller 102 is used as a threshold value of the certain time. Alternatively, it is possible to obtain a transmission timeout value from the image forming apparatus 103 and set this value as the threshold value. Also, it is possible to cause the user to properly input a value on the condition registration screen illustrated in FIG. 14 or 15. Incidentally, since the following processes in S1608 to S1612 are the same as those in S1008 to S1012 in the flow chart illustrated in FIG. 10, the description thereof will be omitted.

<Operation of Image Forming Apparatus 103 to be Performed when Image Forming Apparatus 103 Transmits Network Packet to External Server 114>

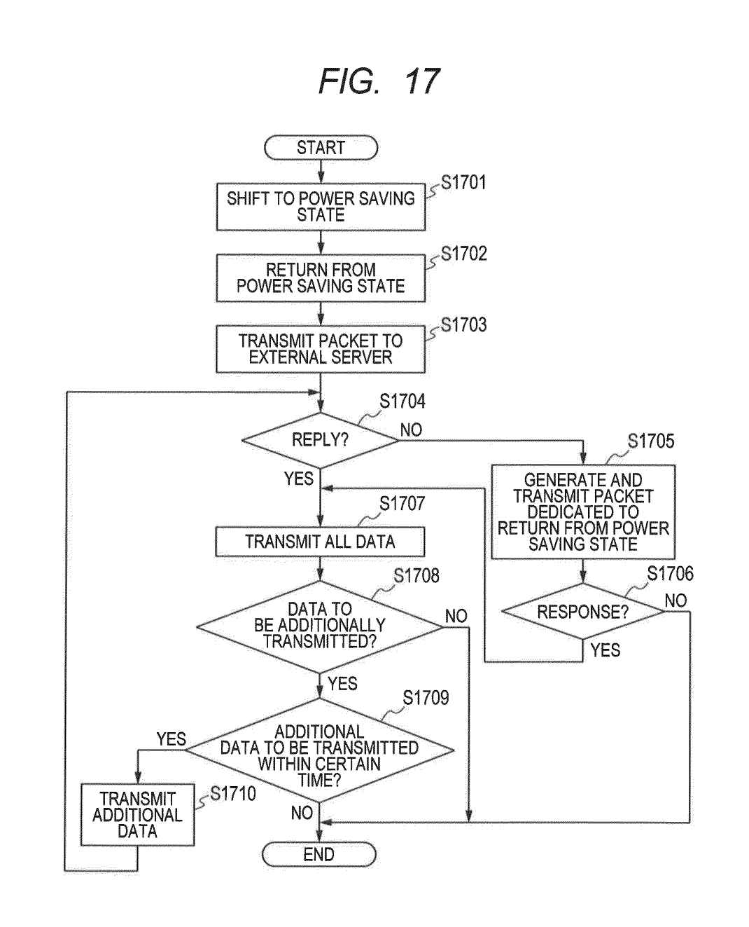

Hereinafter, an operation of the image forming apparatus 103 to be performed when the image forming apparatus 103 transmits a device status and scanning data to the external server 114 under the condition that both the image processing controller 102 and the image forming apparatus 103 are in the power saving state will be described with reference to a flow chart illustrated in FIG. 17.

FIG. 17 is the flow chart for describing an example of the operation of the image forming apparatus 103 according to the third embodiment. Incidentally, it should be noted that each step illustrated in FIG. 17 is achieved on the condition that the CPU 208 executes the program decompressed and expanded in the memory 209.

In the flow chart of FIG. 17, the description of the steps already described about the flow chart of FIG. 13 will be omitted, and only the portions different from the flow chart of FIG. 13 will be mainly described hereinafter. Initially, since the respective processes in S1701 to S1710 are the same as those in S1301 to S1310, the description thereof will be omitted.

If the CPU 208 determines that data to be additionally transmitted does not exist in the image forming apparatus 103 (NO in S1708), or if the CPU determines that data to be transmitted immediately does not exist in the image forming apparatus 103 (NO in S1709), then the entire process in the flow chart is terminated.

In the above embodiment, in the case where the NW I/F 205 receives the packet which is the factor of the process of transferring the data transmitted from the image forming apparatus 103 to the network through the NW I/F 204, it is controlled to return the image processing controller 102 from the power saving state and not shift the image processing controller to the power saving state until the transfer of the data is terminated. Then, in the case where the process of the data is terminated, if there is no additional transmission, it is controlled to shift the image processing controller to the power saving state. However, the process to be performed by the image processing controller 102 on the condition that the image processing controller returns from the power saving state due to the return factor is not limited to the process of transferring the data to the network. Namely, the present invention is also applicable to another process. For example, the present invention is applicable to a process in which the image data received from the image forming apparatus 103 is subjected to an image process and returned to the image forming apparatus 103.

As described above, according to the present embodiment, in the case where the image forming apparatus 103 requests the image processing controller 102 to perform the process, the image forming apparatus can send such a request even if the image processing controller 102 is in the power saving state. Moreover, in the case where the image processing controller 102 returns from the power saving state in response to the request from the image forming apparatus 103, the image processing controller can again shift to the power saving state immediately after the termination of the process requested by the image forming apparatus 103. Consequently, it is possible to maintain the image processing controller 102 with the power saving state as much as possible, thereby achieving energy saving. In other words, it is possible to achieve the power saving without impairing the convenience.

Incidentally, in the above embodiment, the information processing system which comprises the image forming apparatus 103 and the image processing controller 102 is exemplarily used as the information processing system according to the present invention. However, the information processing system according to the present invention is not limited to this. For example, the present invention is also applicable to an information processing system in which an information processing apparatus (i.e., the information processing apparatus other than the image processing controller) capable of shifting to a first power state (e.g., 602, 603) and a second power state (e.g., 604) of which the consumed power is smaller than that of the first power state, and an information processing apparatus (i.e., the information processing apparatus other than the image forming apparatus) capable of shifting to a third power state (e.g., 602, 603) and a fourth power state (e.g., 604) of which the consumed power is smaller than that of the third power state cooperatively operate. More specifically, the present invention is applicable to an information processing system in which a second information processing apparatus transmits/receives data to/from a network through a first information processing apparatus.

As described above, according to the present embodiment, when transmitting the data from the first information processing apparatus to the network, it is possible to transmit the data even if the second information processing apparatus is in the power saving state. Further, in a case where the second information processing apparatus returns from the power saving state by the data transfer from the first information processing apparatus, it is possible for the second information processing apparatus to again shift to the power saving state immediately after the data transmission from the first information processing apparatus to the network is terminated. Consequently, it is possible to maintain the second information processing apparatus with the power saving state as much as possible, thereby achieving energy saving. In other words, it is possible to achieve the power saving without impairing the convenience.

Incidentally, it should be noted that the structures and contents of the used various data are not limited to those as described above. Namely, it is needless to say that various structures and contents may be used according to intended uses and purposes.

Although the preferred embodiments were described as above, the present invention can be carried out as another form such as a system, an apparatus, a method, a program, a storage medium or the like. Besides, the present invention may be applied to a system composed of a plurality of devices or to an apparatus composed of a single device.

Moreover, constitutions obtained by properly combining the above embodiments are also included in the present invention.

### Other Embodiments

Incidentally, it should be noted that the present invention is achieved by performing the process in which software (program) for achieving the functions of the above embodiments is supplied to a system or an apparatus through a network or various storage media and a computer (or a CPU, an MPU or the like) of the system or the apparatus reads and executes the supplied program.

Moreover, the present invention may be applied to a system including a plurality of devices or to an apparatus consisting of a single device.

The present invention is not limited to the above embodiments, various modifications (including organic combinations of the respective embodiments) can be achieved based on the substance of the present invention, and these modifications are not excluded from the scope of the present invention. That is, all the constitutions obtained by properly combining the above embodiments and their modifications are included in the present invention.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD™), a flash memory device, a memory card, and the like.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-125908, filed Jun. 14, 2013, which is hereby incorporated by reference herein in its entirety.

What is claimed is:

1. An information processing apparatus capable of communicating with an image forming apparatus, generating raster image data in response to a print request received from an external apparatus, and transmitting the generated raster image data to the image forming apparatus, comprising:
a receiving unit configured to receive a packet from the image forming apparatus through a network; and
a controlling unit configured to, in a case where the packet received by the receiving unit is a packet addressed to another apparatus different from the information processing apparatus, return the information processing apparatus from a power saving state.

2. The information processing apparatus according to claim 1, wherein the controlling unit further comprises a transmitting unit configured to transmit the packet to the another apparatus.

3. The information processing apparatus according to claim 2, wherein the controlling unit shifts the information processing apparatus to the power saving state according as the transmitting unit transmits the packet to the another apparatus.

4. The information processing apparatus according to claim 1, wherein
in a case where data dedicated to return is received from the image forming apparatus by the receiving unit, the controlling unit returns the information processing apparatus from the power saving state, and
in a case where data to be next transmitted is included in the data dedicated to return, when transfer of the data to be next transmitted is terminated, the controlling unit shifts the information processing apparatus to the power saving state.

5. The information processing apparatus according to claim 1, further comprising a setting unit configured to set a communication protocol to be used, wherein
in a case where the data dedicated to return is received from the image forming apparatus by the receiving unit in the power saving state, the controlling unit returns the information processing apparatus from the power saving state, and
in a case where transfer of data corresponding to the communication protocol set by the setting unit is terminated, the controlling unit shifts the information processing apparatus to the power saving state.

6. The information processing apparatus according to claim 1, wherein the information processing apparatus includes an image processing controller configured to perform an image process in cooperation with the image forming apparatus.

7. An information processing system which comprises an image forming apparatus and an information processing apparatus capable of communicating with the image forming apparatus, generating raster image data in response to a print request received from an external apparatus, and transmitting the generated raster image data to the image forming apparatus, wherein
the information processing apparatus comprises:
a receiving unit configured to receive a packet from the image forming apparatus through a network; and
a controlling unit configured to, in a case where the packet received by the receiving unit is a packet addressed to another apparatus different from the information processing apparatus, return the information processing apparatus from a power saving state.

8. A controlling method of an information processing apparatus capable of communicating with an image forming apparatus, generating raster image data in response to a print request received from an external apparatus, and transmitting the generated raster image data to the image forming apparatus, the method comprising:
receiving a packet from the image forming apparatus through a network; and
returning, in a case where the received packet is a packet addressed to another apparatus different from the information processing apparatus, the information processing apparatus from a power saving state.

9. A non-transitory computer-readable storage medium of storing a program to cause a computer provided in a network interface to function as the unit described in claim 1.
